(19) United States
(12) Patent Application Publication
(10) Pub. No.: US 2013/0033215 A1
(43) Pub. Date: Feb. 7, 2013

(54) APPARATUS AND METHOD FOR PERMANENT MAGNET ELECTRIC MACHINE CONDITION MONITORING

(71) Applicants: Umamaheshwar Krishnamurthy, Wheaton, IL (US); Yao Da, Chicago, IL (US)

(72) Inventors: Umamaheshwar Krishnamurthy, Wheaton, IL (US); Yao Da, Chicago, IL (US)

(73) Assignee: Illinois Institute of Technology, Chicago, IL (US)

(21) Appl. No.: 13/195,461

(22) Filed: Aug. 1, 2011

(51) Int. Cl. H02P 23/14

(52) U.S. Cl. 318/493

(57) ABSTRACT

An apparatus and method for determining a condition of an electric machine. Search coils are wound around stator teeth and the induced voltage is used to decouple stator and rotor fluxes. The decoupled fluxes allow for machine condition monitoring and fault diagnosis.

### BACKGROUND OF THE INVENTION

This invention relates generally to electric machines and, more particularly, to an apparatus and method for determining a condition of an electric machine.

Permanent Magnet Synchronous Machines (PMSMs) have become a preferred choice where high performance is required, due to a relatively high efficiency, high output power to volume ratio, high torque to current ratio, etc. While the PMSM is relatively robust, some failures are inevitable. Several faults can be seen in PMSMs including eccentricity, bearing failure, demagnetization of permanent magnets, short circuit in the stator or armature winding, etc. This necessitates health monitoring and fault diagnosis of the machine to maintain their performance and increase their lifetime.

Since traditional off-line machine fault detection and diagnostic methods do not generally allow for frequent testing, and are financially impractical, many on-line methods have been proposed. Mainstream methods are typically based on spectrum analysis: armature current spectrum or vibration spectrum. The main advantage of this kind of method is that they are generally noninvasive, no additional hardware is required, and do not need an accurate machine model. However, inverters may add unpredictable harmonics to the current spectrum. Also, in some applications when the machine speed is not stationary, it is hard to determine the harmonic orders.

Another kind of method uses negative/zero current, negative/zero impedance, or negative/zero voltage as indicators. These indicators are sensitive to machine asymmetry so that fault-caused unbalance signals can be detected. However, any asymmetry caused by the machine structure or the power supply's unbalance could influence the fault detection. Parameter estimation is another scheme that is able to perform online fault diagnosis through detecting abnormal physical parameters. The disadvantage of this scheme is that an accurate machine model is required.

Machine operation failures not only happen to the machine itself, but also to the drive system, including transistor switches, gate drive circuit, current sensors or encoder, etc. In this invention, a backup universal sensor is also provided by the apparatus, to give the PMSM's drive system an “N+1” redundancy. Many position sensorless techniques have been developed over the last three decades. One type of the sensorless techniques is based on machine model. The rotor's flux vector can be estimated based on a known machine model and current information. However, an accurate machine model and adaptive observers are required for the position estimation, such as a model reference adaptive system and extended Kalman filter, etc. For internal permanent-magnet synchronous machines, there is saliency between direct and quadrature axes of rotor inductance. Position information can be derived by processing current signals, using high frequency voltage injected into the stator windings. These high frequency signal injection based methods allow for reliable position estimation under low and zero speed operation condition. But they are not suitable for surface mounted permanent magnet synchronous machines. Also additional hardware is usually required in the process of high frequency signal injection and detection. Another type of position sensorless techniques is based on back EMF. The position vector can be estimated by integration of the back EMF. However, phase back EMF is usually not accessible in a drive system, since the neutral line is rarely provided, and because back EMF voltage is quite low under low speed operation condition, the estimated position is very sensitive to stator resistance variations and measurement noise.

Current information is another vital element for PMSM control, either for vector control or direct torque control. Generally, the current measurement methods can be categorized in voltage drop based and observer based. In voltage drop based methods, current information is usually extracted from the voltage drop of a small sensor resistor or a power electronic transistor with a linear voltage-current curve. In observer based methods, current can be estimated from the voltage across inductors.

These position and current sensorless techniques provide cost-effective solution for PMSM drive. Some have already been implemented in industry and household appliances. However, for mission critical applications, such as automotive, industrial machinery, energy generating etc, position and current transducers are still indispensable due to the requirement for high reliability and accuracy. There is continuing need for improved condition detection for electric machines, and particularly PMSMs.

### SUMMARY OF THE INVENTION

A general object of the invention is to provide a multi-faults detection method using search coils. Search coils are wound around armature teeth, typically needing to be installed during machine manufacturing. The device and method of this invention have a general immunity to high frequency harmonics, which makes them suitable for inverter/rectifier fed motors or generators, such as wind turbines and automotive systems. In addition, this method does not require the knowledge of machine parameters. Since the air-gap flux is directly measured with this device and method, improved diagnosis reliability is provided. Conditions such as eccentricity, armature winding short-turn, and demagnetization faults can be detected, and the same device search coils can also at as a backup “universal” sensor for current and/or position sensors.

The general object of the invention can be attained, at least in part, through an electric machine. The electric machine includes a rotor including a permanent magnet, a stator including a plurality of stator teeth each including an armature winding, a plurality of search coils each wound around a different one of the stator teeth, and a monitoring device in communicating combination with each of the search coils. The monitoring device receives induction voltage from the search coils and includes a data processor determining an armature flux from the induction voltage or determining rotor flux from measured armature current and collective magnetic flux.

The invention further comprehends a method for determining a condition of an electric machine including a rotor and a stator. The method includes measuring a magnetic machine flux of the electric machine; measuring a field flux of the rotor, and determining with a data processor in combination with the electric machine an armature flux of the stator as a function of the measured field flux and the measured collective magnetic machine flux. The flux measurements can be obtained with the search coils wound around the stator teeth.

The invention still further comprehends a method for determining a condition of an electric machine including a rotor and a stator, including providing a first electric machine property selected from at least one of a first field flux of the rotor or a first armature flux of the stator, and determining with at least one of a sensor or a data processor in combination with the sensor during operation of the electric machine a second electric machine property selected from at least one of a second field flux of the rotor or a second armature flux of the stator. The data processor compares the second electric machine property with the first electric machine property, and determines a potential or actual machine fault during operation of the electric machine upon the second electric machine property differing from the first electric machine property by a predetermined amount.

The invention still further comprehends a method for determining a condition of an electric machine including a rotor and a stator, including measuring with a data processor an induced voltage formed on a search coil wound around a stator of the electric machine, detecting one of stator current or rotor position with a sensor and the data processor; and determining with the data processor an other of the stator current or rotor position as a function of the induced voltage.

Other objects and advantages will be apparent to those skilled in the art from the following detailed description taken in conjunction with the appended claims and drawings.

### BRIEF DESCRIPTION OF THE DRAWINGS

FIG. 1 illustrates a representative geometric configuration schematic of a PMSM according to one embodiment of this invention.

FIG. 2 is a phasor/vector diagram for one phase of the PMSM, according to one embodiment of this invention.

FIG. 3 illustrates a static air-gap length around an air-gap according to one embodiment of this invention.

FIG. 4 illustrates flux in teeth and back iron according to one embodiment of this invention.

FIG. 5 illustrates a three phase flux linkage vector summation.

FIG. 6 summarizes flux density around an air-gap according to one embodiment of this invention.

FIG. 7 is a space diagram illustrating actual and estimated d-q axes according to one embodiment of this invention.

FIG. 8 is a schematic of a rotor position estimator according to one embodiment of this invention.

FIG. 9 is a schematic of a sliding mode current observer sensor according to one embodiment of this invention.

FIG. 10 illustrates measured voltage and phase with different loads.

FIG. 11 illustrates decoupled voltage in (a) the armature component and (b) the field component.

FIG. 12 illustrates a field component in a static eccentricity running machine.

FIG. 13 illustrates a field component in a dynamic eccentricity running machine.

FIG. 14 illustrates an armature component in an inter-turn shorted machine.

FIG. 15 illustrates an armature component in a one phase grounded machine.

FIG. 16 illustrates a field component in a one pole pair demagnetized machine.

FIG. 17 illustrates a field component in a uniform demagnetized machine

FIG. 18 is a schematic of a configuration of a co-simulation of vector control.

FIG. 19 shows a three phase current and corresponding search coil voltage at starting: (a) phase A current, (b) phase A search coil voltage, (c) phase B current (d), phase B search coil voltage, (e) phase C current, and (f) phase C search coil voltage.

FIG. 20 shows an actual and estimated position at starting.

FIG. 21 shows an actual and estimated position at steady state

FIG. 22 shows an actual and estimated current at starting

FIG. 23 shows an experimental three phase current and corresponding search coil voltage at steady state: (a) phase A current, (b) phase A search coil voltage, (c) phase B current, (d) phase B search coil voltage, (e) phase C current, and (f) phase C search coil voltage.

FIG. 24 shows an experimental actual and estimated position at starting

FIG. 25 shows an experimental actual and estimated position at steady state.

FIG. 26 shows an experimental actual current related to estimated current.

### DETAILED DESCRIPTION OF THE INVENTION

The present invention provides a condition monitoring apparatus and method for use in fault and other condition determination of an electric machine. Although the invention will be principally described with reference to embodiments of a PMSM having twelve stator poles and eight rotor poles, machines of other types and sizes, and having other than three phases or twelve stator poles may be designed in accordance with the invention.

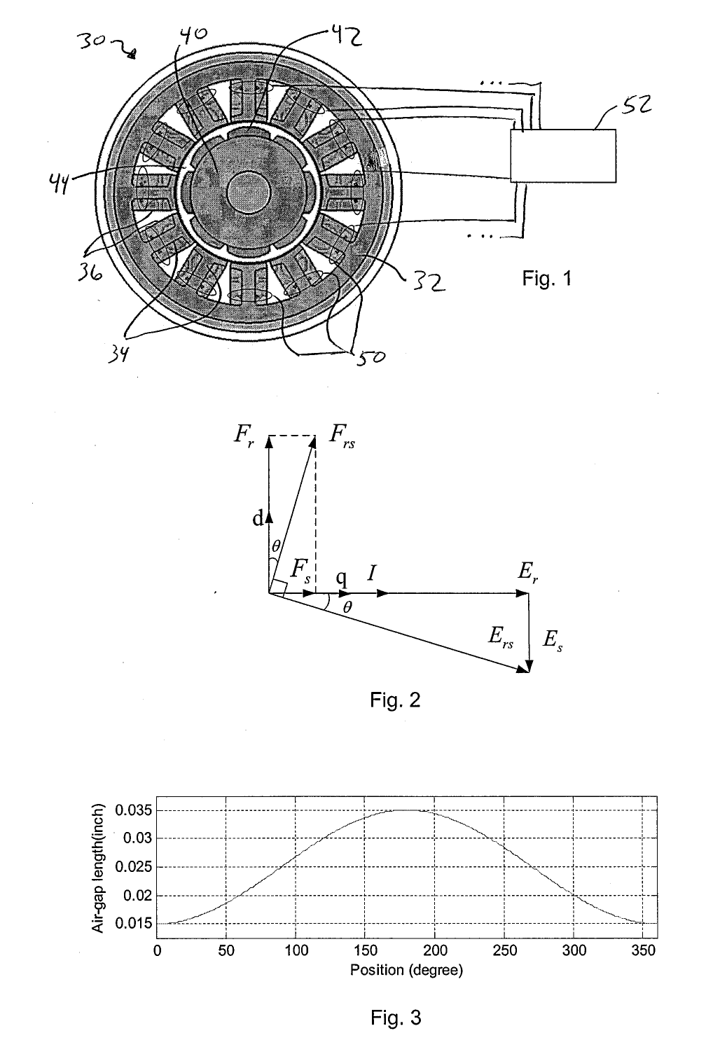

FIG. 1 illustrates a known construction of a four-phase pole PMSM 30. The known PMSM 30 includes a stator 32 with twelve stator teeth 34 each having a coil 36 wound around each stator pole 34. The coils 36 on diametrically opposite stator teeth pairs are connected in series or in parallel to form a phase of the machine. The three phase Y-connected machine of FIG. 1 has a concentrated armature winding and a sinusoidal back EMF. The rotor 40 includes permanent magnet rotor teeth or poles 42, separated from the stator teeth 34 by an air-gap 44.

To operate the PMSM 30 as a motor, each phase is normally connected to an electrical energy source through semiconductor devices. Clock-wise sequencing of phase excitation would produce counter-clock-wise rotation of the rotor 40 and the shaft the rotor is connected to. Usually a phase is kept energized until any two of the rotor poles align themselves with those stator poles having energized coils. This position is referred to as a minimum reluctance position because reluctance to the flux path is at its least between opposite stator poles when the coils on those stator poles experience current flow. The next phase would then be energized once the rotor poles are aligned with corresponding stator poles.

In one embodiment of this invention, a search coil 50 is wound around at least one, and desirably all, stator teeth 34. Each search coil 50 is desirably a separate metal winding around each of the individual stator teeth 34. A monitoring device 52 (representatively shown) is in communicating combination with each of the search coils 50. The monitoring device 52 measures induction voltage from the search coils 50, and includes a data processor for determining conditions of the electric machine according to the methods of this invention.

The search coils 50 and monitoring device 52 are useful in determining a condition of the electric machine. In one embodiment, the search coils 50 provide for health monitoring and/or fault diagnosis. Each search coil 50 generates voltage, following the principle of electromagnetic induction. The search coils 50 monitor the flux distribution around the machine's air-gap 44 followed by signal processing by the monitoring device 52. This provides information to adequately determine health of the machine 30 or a specific faults in the machine 30, such as, without limitation, demagnetization, stator winding short-circuit, and/or open-circuit faults.

In one embodiment of the invention, the search coils 50 and monitoring device 52 measure a magnetic machine flux of the electric machine and a field flux of the rotor. The measured fluxes are used in a decoupling step to determining with the data processor an armature flux of the stator as a function of the measured field flux and the measured collective magnetic flux.

The magnetic machine flux of the electric machine 30 can be measured by powering and operating the machine 30. The field flux of the permanent magnet rotor 40 can, in one embodiment of this invention, be determined by operating the electric machine 30 without an introduced power current to measure the field flux of the rotor 40. For example, the electric machine rotor 40 can be spun using a second and powered electric machine, so that the rotor flux is measured without any influence from the electric current. The rotor flux can be determined for each machine, or for a type of machine using a specimen. However, it may be desirable to determine the rotor flux of more than one similar machine in case the single machine has any rotor or other deficiencies due to manufacturing or storage issues.

In one embodiment of this invention, the data processor 52 determines the armature flux by decoupling the field flux from the magnetic machine flux using a vector calculation. Each search coil 50 measures a vector summation of flux due to permanent rotor magnets and armature coils induced flux, when there is no saturation. To analyze the reason of a change in flux or a flux unbalance, the rotor 40 and stator 32 are decoupled. FIG. 2 is a phasor diagram for the operation of a PMSM as a generator. When no load is mounted and the rotor 40 is revolving at the synchronous speed, back EMF Eᵣ at the search coil 50 is produced by the field MMF Fᵣ in each phase. The MMF distribution can be described as space vectors, where the EMFs are time phasors. The superposition of the filed MMF and the armature MMF, known as armature reaction, produces resultant air-gap 44 MMF Fᵣₛ, which is the vector sum of Fᵣ and Fₛ. Additionally, this MMF is responsible for the resultant air-gap flux which induces a back EMF in the search coil under load, denominated as Eᵣₛ in FIG. 2.

In one embodiment of this invention, the electric machine is controlled using vector control scheme where phase current I has the same direction of q axis. Thus the armature reaction voltage Eₛ leads Eᵣ by 90 degrees. Thus they can be decoupled as following:

Eᵣ=Eᵣₛ cos θ (1)

and

Eₛ=Eᵣₛ sin θ (2)

where θ is angle between the rotor MMF and the resultant air-gap MMF. The decoupled rotor and stator flux information, namely the initial machine field flux and an initial machine armature flux, can be used to monitor for conditions, such as determining machine faults, during electric machine operation by monitoring an operating field flux and an operating armature flux during operation of the electric machine. The search coils 50 wound around the stator teeth 34 directly measure or monitor the flux distribution around the machine's air-gap 44. Followed by filtering and decoupling steps performed by the monitoring device 52, the location and severity of specific faults of the machine 30 can be determined, even the direction of static eccentricity and the location of stator winding short circuits. As only the fundamental frequency is used for analysis, influence caused by the machine drive circuit is eliminated and there is no tradeoff between time and frequency resolution.

The invention includes an eccentricity fault modeling and determination method. Eccentricity in a machine is a condition of an uneven air-gap between the stator and rotor. If the condition is severe, the Unbalanced Magnetic Pull (UMP) could cause stator and rotor contact. Generally, eccentricity is classified into three types: Static eccentricity, dynamic eccentricity and mixed eccentricity.

Static eccentricity occurs when there is a displacement of the axis of rotation, which usually can be caused by an oval stator or misaligned mounting of bearings, rotors, or stators. Static eccentricity ratio is defined as:

$${\vec{e}}_{s} = \frac{{\vec{ɛ}}_{s}}{g} \qquad ( 3 )$$

where εₛ is the radial distance between rotor axis and stator axis, and g is the uniform air-gap length. Thus the eccentricity ratio has the limit as follows:

0≦|\vec{e}ₛ|≦1 (4)

Dynamic eccentricity is the condition in which the stator axis and the rotor rotation axis are identical, but the rotor's axis is displaced to some extent. Therefore the minimum air-gap length position rotates around. This case is usually caused by bent shaft, misaligned mounting of bearings, etc. Similarly, the dynamic eccentricity ratio is defined as:

$${\vec{e}}_{d} = \frac{{\vec{ɛ}}_{d}}{g} = \frac{\vert {\vec{ɛ}}_{d} \vert ∠ω t}{g} \qquad ( 5 )$$

where ε_{d} is the radical distance between rotor's axis and stator's axis.

Mixed eccentricity is the combination of static and dynamic eccentricity, which is defined by equations 6 and 7.

$$\begin{matrix}\vert {\vec{e}}_{m} \vert = \vert \frac{{\vec{ɛ}}_{s}}{g} + \frac{{\vec{ɛ}}_{d}}{g} \vert = \sqrt{{\vert {\vec{e}}_{s} \vert}^{2} + {\vert {\vec{e}}_{d} \vert}^{2} + 2 \vert {\vec{e}}_{s} \vert \vert {\vec{e}}_{d} \vert cos ( ω t )} & ( 6 ) \\ ∠ϕ = ∠ {\vec{e}}_{m} = {tan}^{- 1} \frac{\vert {\vec{e}}_{d} \vert sin ( ω t )}{\vert {\vec{e}}_{s} \vert + \vert {\vec{e}}_{d} \vert cos ( ω t )} & ( 7 )\end{matrix}$$

where φ is the angle of the mixed eccentricity, with a reference to static eccentricity direction. It is a time dependent variant with a period the same as the rotor. Thus, the air-gap length l could be calculated as:

lₐᵢᵣ(ζ, t)=Rₛ−|\vec{e}ₘ|g cos(ζ−φ)−\sqrt{Rᵣ²−|\vec{e}ₘ|² g² sin²(ζ−φ)} (8)

where ζ is the position around the air-gap, from 0 to 360 degree. FIG. 3 illustrates the air-gap length of an exemplary PMSM as a function of position, operating with 40% static eccentricity. For dynamic eccentricity air-gap length, it has exactly the same curve but it moves towards one direction at the same speed as the rotor. For mixed eccentricity, the air-gap length is simply the numerical summation of these two minus the average air-gap length.

Magnetic flux is MMF divided by reluctance. In a machine's magnetic circuit, reluctance is a function of the air-gap length and back iron equivalent length lᵢᵣₒₙ, as given by:

$$Φ ( ζ , t ) = \frac{F}{{R}_{air} + {R}_{iron}} = \frac{F}{\frac{{l}_{air} ( ζ , t )}{{μ}_{o} {A}_{air}} + \frac{{l}_{iron}}{{μ}_{o} {μ}_{r} {A}_{iron}}} \qquad ( 9 )$$

where Φ is magnetic flux through a search coil, F is MMF produced by permanent magnets, Rₐᵢᵣ and Rᵢᵣₒₙ are reluctance of the air-gap and back iron respectively, μ₀ is the permeability of the air, and μᵣ is the relative permeability of the back iron. If only static eccentricity exists, lₐᵢᵣ is just a function of position, so Φ is also time irrelevant. If dynamic eccentricity exists, Φ will be a function of both position and time. Using the above method and calculations, the changes in flux can be analyzed to determine if a flux change is the result of an eccentricity fault, and what type of eccentricity fault has occurred.

The invention also includes an armature short circuit fault model and determination method. Armature winding faults are usually cased by insulation failure. They are commonly classified into phase-to-phase short circuit, phase-to-ground short circuit, or inter-turn short circuit. In phase-to-phase short circuit, fuses might burn and the machine could stop. In a phase-to-ground short circuit, if the machine still runs, large torque ripple can be found. In an inter-turn short circuit, the faulty winding has a smaller number of effective turns than the other healthy windings, so one can find an asymmetry in machine's armature current or armature MMF. This signature can be used as an indicator in the method of this invention.

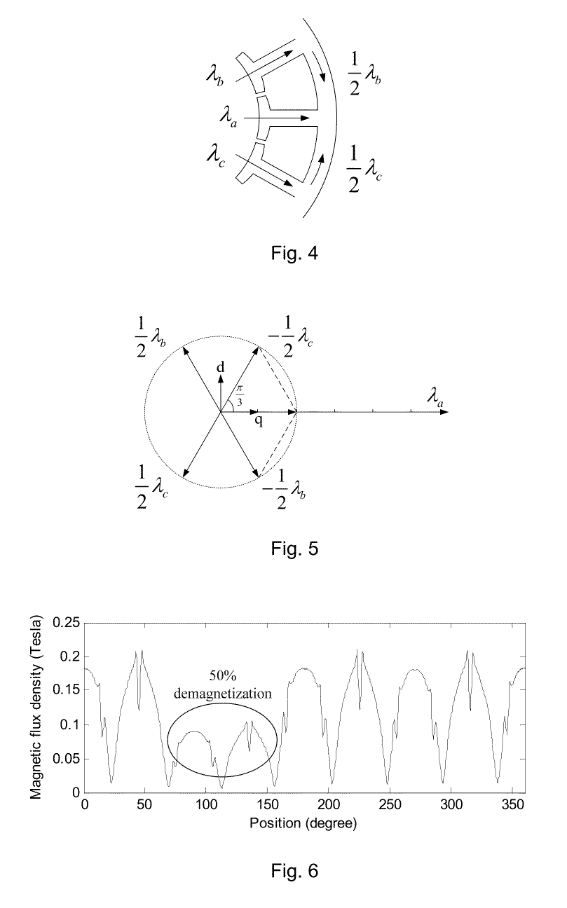

FIG. 4 shows the path for the coupling of flux when only the armature MMFs are considered. Applying KCL provides:

$${λ}_{A} = {λ}_{a} - \frac{1}{2} {λ}_{b} - \frac{1}{2} {λ}_{c} \qquad ( 10 )$$

where λ_{A} is the flux linkage through Teeth A, λₐ is the flux linkage produced by coil around Teeth A, λ_{b} is the flux linkage produced by coil around Teeth B, and λ_{c} is the flux linkage produced by coil around Teeth C. The phasor diagram for this arrangement is shown in FIG. 5, and illustrates that when a phase-to-ground short circuit occurs at phase a, there will still be 1/3 flux linkage produced by adjacent armature winding. In most cases with low voltage machines, the faults are bolted. If phase b is shorted, there will be 5/6 flux linkages left at q-axis, whereas some d-axis armature MMF component exists. Thus the remaining flux linkage λ_{f} during inter-turn short-circuit can be expressed as

$${λ}_{f} = \frac{2 N}{3 n} λ \qquad ( 11 )$$

where λ is the flux linkage through the same coil in a healthy machine, N is the total number of turns, and n is the number of shorted turns. Using the above method and calculations, the changes in flux at the search coils can be analyzed to determine if a flux change is the result of an armature fault.

The invention further includes an eccentricity fault modeling and determination method. The permanent magnets in a PMSM could be demagnetized in applications that require operation at high temperatures, high impropriate armature current, or even by the aging of the magnets themselves. The demagnetization could be uniform over all poles, or partial over certain regions or poles. For partial demagnetization, two out of eight magnetic poles' coercivity is reduced by 50%. This modifies the magnetic flux density distribution as shown in FIG. 6. The small notches in this figure are caused by slot effect. For uniform demagnetization, all the poles' coercivity is reduced by 50%, so the flux density distribution's shape remains the same, except the scale. Thus providing a basis for determination of demagnetization faults.

Machine operation failure not only happens to the electric machine itself, but also happens to the drive system, including transistor switches, gate drive circuit, current sensors, or encoder, etc. The invention further provides a backup universal sensor using the search coils 50, to give the electric machine an “N+1” redundancy. The search coils 50 and the monitoring device 52 have the ability to function as a position sensor or current sensors.

One current sensorless technique is based on machine model. The rotor's flux vector can be estimated based on a known machine model and current information. However, an accurate machine model and an adaptive observer is required for the position estimation, such as a model reference adaptive system and extended Kalman filter. For internal permanent-magnet synchronous machines, there is saliency between direct and quadrature axes of rotor inductance.

Position information can be derived by current signals processing, based on the high frequency voltage injected on the stator winding. These high frequency signal injection-based methods allow for reliable position estimation under low and zero speed operation condition, but are not typically suitable for surface mounted permanent magnet synchronous machines, as additional hardware is usually required in the process of high frequency signal injection and detection. Another type of position sensorless techniques is based on back EMF. The position vector can be estimated by integration of the back EMF. However, phase back EMF is usually not achievable in a machine drive system, since the neutral line is rarely provided. Also because the back EMF voltage is quite low under low speed operation condition, the estimated position result is very sensitive to stator resistance variations or measurement noise. Thus resistance estimation is one of the key challenges for back EMF based methods. Current information is another vital element for PMSM control, either for vector control or direct torque control. As discussed above, the current measurement methods can be categorized as voltage drop based and observer based methods. In voltage drop based methods, current information is usually extracted from the voltage drop of a small sensor resistor or a power electronic transistor with a linear voltage-current curve, thus an additional resistor is required. In observer based methods, current can be estimated from the voltage across inductors. The search coil position and/or current sensor of one embodiment of this invention is implemented based upon the induced voltage. The search coils 50 wound around the stator teeth 34 directly monitor the flux change through each phase. The monitoring device 52, though filtering and decoupling steps, determines the position or phase current information.

The invention includes a sensor provided by at least some of the included search coils, and desirably at least one search coil per phase for use as a position and/or current sensor. The search coil 50 and monitoring device 52 can be used to determine an induced voltage formed on the search coil 50. The monitoring device 52 detects one of stator current or rotor position and then determines the other of the stator current or rotor position as a function of the induced voltage.

In one embodiment of this invention, one or more of the search coils can be used as a rotor position sensor. A basic mathematical model for PMSM in rotating d-q axis is given as:

$$[ \begin{matrix}{u}_{q} \\ {u}_{d}\end{matrix} ] = [ \begin{matrix}{R}_{s} + {L}_{q} \frac{d }{d t} & {ω}_{e} {L}_{d} \\ - {ω}_{e} {L}_{q} & {R}_{s} + {L}_{d} \frac{d }{d t}\end{matrix} ] [ \begin{matrix}{i}_{q} \\ {i}_{d}\end{matrix} ] + {K}_{e} {ω}_{c} [ \begin{matrix}1 \\ 0\end{matrix} ] \qquad ( 12 )$$

where subscripts d and q denote variables in d and q axis respectively. Variables R, L, u, i, ωₑ and Kₑ represent stator resistance, stator inductance, terminal voltage, phase current, electrical angular speed and back EMF constant respectively. Due to the high input impedance of ADC channels of DAQ or DSP, current flowing through the search coils can be neglected. Therefore the terminal voltage of search coils can be expressed as:

$$[ \begin{matrix}{u}_{q\_s} \\ {u}_{d\_s}\end{matrix} ] = [ \begin{matrix}{M}_{q\_s} + \frac{d }{d t} & ω {M}_{d\_s} \\ - ω {M}_{q} & {M}_{d\_s} \frac{d }{d t}\end{matrix} ] [ \begin{matrix}{i}_{q} \\ {i}_{d}\end{matrix} ] + {K}_{e\_s} ω [ \begin{matrix}1 \\ 0\end{matrix} ] \qquad ( 13 )$$

where u_{d}_{_{—}}ₛ and u_{q}_{_{—}}ₛ are the search coils' terminal voltages in the d and q axes, M_{d}_{_{—}}ₛ and M_{q}_{_{—}}ₛ are the mutual inductance between phase winding and search coils in the d and q axes, and Ke_s is the back EMF constant of search coils.

For a position estimator, an estimated electrical angle θₑ is assumed. Compared with the actual electrical angle θ_{α}, the angular difference is defined as:

Δθ=θₐ−θₑ (14)

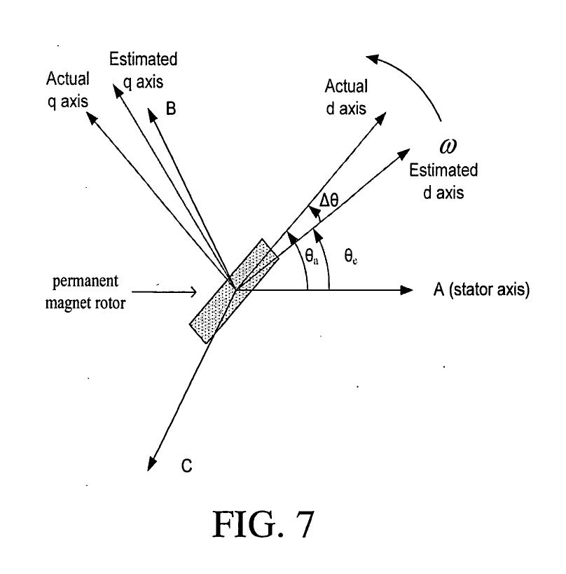

Their relationship is illustrated in FIG. 7. The relationship between estimated rotating coordinate system and the actual rotating coordinate system is given as:

$$\begin{matrix}[ \begin{matrix}{u}_{q}^{e} \\ {u}_{d}^{e}\end{matrix} ] = T ( Δ θ ) [ \begin{matrix}{u}_{q}^{a} \\ {u}_{d}^{a}\end{matrix} ] and & ( 15 ) \\ [ \begin{matrix}{i}_{q}^{e} \\ {i}_{d}^{e}\end{matrix} ] = T ( Δ θ ) [ \begin{matrix}{i}_{q}^{a} \\ {i}_{d}^{a}\end{matrix} ] & ( 16 )\end{matrix}$$

where superscript e and a denote variables in estimated d-q axis reference frame and actual d-q axis reference frame respectively, and:

$$T ( Δ θ ) = [ \begin{matrix}cos ( Δ θ ) & sin ( Δ θ ) \\ - sin ( Δ θ ) & cos ( Δ θ )\end{matrix} ] \qquad ( 17 )$$

Multiplying T(Δθ) to both sides of equation (13) results in:

$$[ \begin{matrix}{u}_{q \_ s}^{e} \\ {u}_{d \_ s}^{e}\end{matrix} ] = T ( Δ θ ) = [ \begin{matrix}{M}_{q \_ s} \frac{d}{d t} & ω {M}_{d \_ s} \\ - ω {M}_{q \_ s} & {M}_{d \_ s} \frac{d}{d t}\end{matrix} ] {T ( Δ θ )}^{- 1} [ \begin{matrix}{i}_{q}^{e} \\ {i}_{d}^{e}\end{matrix} ] + {k}_{e} ω [ \begin{matrix}cos ( Δ θ ) \\ - sin ( Δ θ )\end{matrix} ] \qquad ( 18 )$$

Combining equation (17) and equation (18) results in:

$$[ \begin{matrix}{u}_{q \_ s}^{e} \\ {u}_{d \_ s}^{e}\end{matrix} ] = [ \begin{matrix}\begin{matrix}{cos}^{2} ( Δ θ ) {L}_{q \_ s} \frac{d}{d t} - \\ sin ( Δ θ ) cos ( Δ θ ) ω {L}_{q \_ s}\end{matrix} & \begin{matrix}{cos}^{2} ( Δ θ ) ω {L}_{d \_ s} + \\ sin ( Δ θ ) cos ( Δ θ ) {L}_{d \_ s} \frac{d}{d t}\end{matrix} \\ \begin{matrix}+ sin ( Δ θ ) cos ( Δ θ ) ω {L}_{d \_ s} + \\ {sin}^{2} ( Δ θ ) {L}_{ d \_ s} \frac{d}{d t}\end{matrix} & \begin{matrix}- sin ( Δ θ ) cos ( Δ θ ) {L}_{d \_ s} \frac{d}{d t} + \\ {sin}^{2} ( Δ θ ) ω {L}_{q \_ s}\end{matrix} \\ \begin{matrix}- {cos}^{2} ( Δ θ ) ω {L}_{q \_ s} - \\ sin ( Δ θ ) cos ( Δ θ ) {L}_{ q \_ s} \frac{d}{d t} +\end{matrix} & \begin{matrix}{cos}^{2} ( Δ θ ) {L}_{d \_ s} \frac{d}{d t} - \\ sin ( Δ θ ) cos ( Δ θ ) ω {L}_{d \_ s}\end{matrix} \\ \begin{matrix}sin ( Δ θ ) cos ( Δ θ ) {L}_{d \_ s} \frac{d}{d t} - \\ {sin}^{2} ( Δ θ ) ω {L}_{q \_ s}\end{matrix} & \begin{matrix}+ sin ( Δ θ ) cos ( Δ θ ) ω {L}_{d \_ s} + \\ {sin}^{2} ( Δ θ ) {L}_{q \_ s} \frac{d}{d t}\end{matrix}\end{matrix} ] [ \begin{matrix}{i}_{q}^{e} \\ {i}_{d}^{e}\end{matrix} ] + {k}_{e} ω [ \begin{matrix}cos ( Δ θ ) \\ - sin ( Δ θ )\end{matrix} ] \qquad ( 19 )$$

In the case of M_{q}_{_{—}}ₛ and M_{d}_{_{—}}ₛ being equal or very close for IPM, equation (19) can be simplified to

$$[ \begin{matrix}{u}_{q \_ s}^{e} \\ {u}_{d \_ s}^{e}\end{matrix} ] = [ \begin{matrix}{M}_{s} \frac{d}{d t} & ω {M}_{s} \\ - ω {M}_{s} & {M}_{s} \frac{d}{d t}\end{matrix} ] [ \begin{matrix}{i}_{q}^{e} \\ {i}_{d}^{e}\end{matrix} ] + {k}_{e} ω [ \begin{matrix}cos ( Δ θ ) \\ - sin ( Δ θ )\end{matrix} ] \qquad ( 20 )$$

where Mₛ=M_{d}_{_{—}}ₛ=M_{q}_{_{—}}ₛ. Dividing the bottom terms by the upper terms of equation (20) results in:

$$\frac{{u}_{d \_ s}^{e} + ω {M}_{s} {i}_{q}^{e} - {M}_{s} \frac{d {i}_{d}^{e}}{d t}}{{u}_{q \_ s}^{e} - ω {M}_{s} {i}_{d}^{e} - {M}_{s} \frac{d {i}_{q}^{e}}{d t}} = \frac{- {k}_{e} ω sin ( Δ θ )}{{k}_{e} ω cos ( Δ θ )} \qquad ( 21 )$$

In reality, due to the current sensor's noise and ADC measurement noise, using a derivative of current is generally not preferred unless very accurate sensors are used. A common way is to implement an analog or digital low pass filter, therefore one can have:

$$\{ \begin{matrix}\frac{d {i}_{d}^{e}}{d t} • & {ω}_{s} {i}_{q}^{e} \\ \frac{d {i}_{q}^{e}}{d t} • & {ω}_{s} {i}_{d}^{e}\end{matrix} \qquad ( 22 )$$

as long as the rotor is not at standstill or running at very low speed conditions. Thus from equation (21) one can obtain:

$$tan ( Δ θ ) = \frac{- {u}_{d \_ s}^{e} - ω {M}_{s} {i}_{q}^{e}}{{u}_{q \_ s}^{e} - ω {M}_{s} {i}_{d}^{e}} \qquad ( 23 )$$

Assuming that the estimated angle is very close to the actual angle, one can obtain:

tan(Δθ)≈Δθ (24)

Thus the estimated rotor position can be kept updated as:

θₙ₊₁=θₙ+Δθ (25)

at each time intervals. It should be noticed that:

tan(Δθ+π)=tan(Δθ) (26)

therefore the estimated position can also converge to θ+π. To avoid this issue, equation (13) can be modified to

θₙ₊₁=θₙ+Δθ+π·h

where:

$$h = \{ \begin{matrix}1 & if sign ( {u}_{q \_ s}^{e} - ω {M}_{s} {i}_{d}^{e} ) < 0 \\ 0 & if sign ( {u}_{q \_ s}^{e} - ω {M}_{s} {i}_{d}^{e} ) > 0\end{matrix} \qquad ( 27 )$$

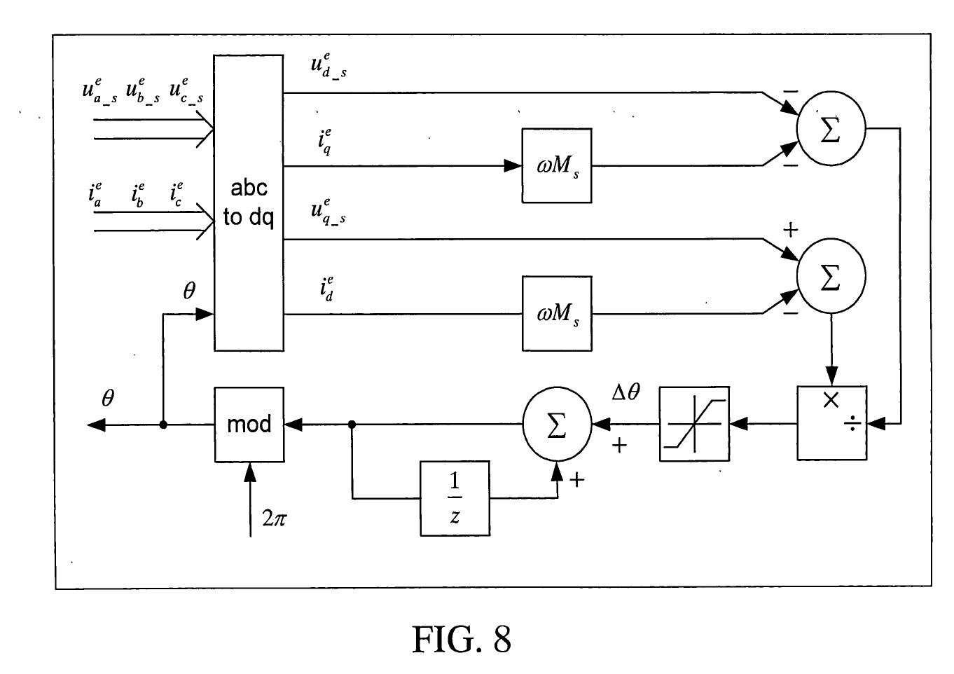

because cos(Δθ) in equation (21) should be close to one, not minus one. Therefore, the overall system is illustrated in FIG. 8.

In another embodiment of this invention, one or more of the search coils and monitoring device can be used as a current sensor and/or estimation device. From equation (13), one can also get

$$[ \begin{matrix}\frac{d {i}_{q}}{d t} \\ \frac{d {i}_{d}}{d t}\end{matrix} ] = [ \begin{matrix}0 & - ω \frac{{M}_{d \_ s}}{{M}_{q \_ s}} \\ ω \frac{{M}_{q \_s}}{{M}_{d \_ s}} & 0\end{matrix} ] [ \begin{matrix}{i}_{q} \\ {i}_{d}\end{matrix} ] + [ \begin{matrix}\frac{{u}_{q \_ s} - {K}_{e \_ s} ω}{{M}_{q \_ s}} \\ \frac{{u}_{d \_ s}}{{M}_{ d \_ s}}\end{matrix} ] \qquad ( 28 )$$

Therefore, the d and q axis current can be obtained by solving these two differential equations. However, it is not an asymptotically stable system, which means one cannot just use this equation to achieve current estimation. Therefore a sliding mode observer is designed as follows.

Assuming phase current are sinusoidal, on the stator α β reference frame, one can have:

$$\{ \begin{matrix}\frac{d {i}_{α}}{d t} = - {ω }_{e} {i}_{β} \\ \frac{d {i}_{β}}{d t} = {ω}_{e} {i}_{α}\end{matrix} \qquad ( 29 )$$

Therefore the system on the α β reference frame can be expressed as a linear time-invariant system under the assumption that the electrical rotor speed varies much slower than current, shown as:

$$[ \begin{matrix}{\dot{λ}}_{α} \\ {\dot{λ}}_{β} \\ {\dot{i}}_{α} \\ {\dot{i}}_{β}\end{matrix} ] = [ \begin{matrix}0 & 0 & 0 & {ω}_{e} {M}_{s} \\ 0 & 0 & - {ω}_{e} {M}_{s} & 0 \\ 0 & 0 & 0 & - {ω}_{e} \\ 0 & 0 & {ω}_{e} & 0\end{matrix} ] [ \begin{matrix}{λ}_{α} \\ {λ}_{β} \\ {i}_{α} \\ {i}_{β}\end{matrix} ] + [ \begin{matrix}1 & 0 \\ 0 & 1 \\ 0 & 0 \\ 0 & 0\end{matrix} ] [ \begin{matrix}{u}_{α \_ s} \\ {u}_{β \_ s}\end{matrix} ] \qquad ( 30 )$$

with output vector:

$$[ \begin{matrix}{λ}_{α} \\ {λ}_{β}\end{matrix} ] = [ \begin{matrix}1 & 0 & 0 & 0 \\ 0 & 1 & 0 & 0\end{matrix} ] [ \begin{matrix}{λ}_{α} \\ {λ}_{β} \\ {i}_{α} \\ {i}_{β}\end{matrix} ] \qquad ( 31 )$$

where α is a variable in the α axis, and β is a variable in the β axis. This can be simplified to:

$$[ \begin{matrix}\dot{λ} \\ \dot{i}\end{matrix} ] = [ \begin{matrix}0 & - {ω}_{e} {M}_{s} J \\ 0 & {ω}_{e} J\end{matrix} ] [ \begin{matrix}λ \\ i\end{matrix} ] + [ \begin{matrix}I \\ 0\end{matrix} ] u \\ where λ = {[ \begin{matrix}{λ}_{α} & {λ}_{β}\end{matrix} ]}^{T} ; i = {[ \begin{matrix}{i}_{α} & {i}_{β}\end{matrix} ]}^{T} ; u = {[ \begin{matrix}{u}_{α \_ s} & {u}_{β \_ s}\end{matrix} ]}^{T} ; \\ I = [ \begin{matrix}1 & 0 \\ 0 & 1\end{matrix} ] ; and J = [ \begin{matrix}0 & - 1 \\ 1 & 0\end{matrix} ] . \qquad ( 32 )$$

Based upon the system model in equation (31), a sliding mode observer is designed as:

$$[ \begin{matrix}{λ}^{\dot{\hat{}}} \\ {i}^{\dot{\hat{}}}\end{matrix} ] = [ \begin{matrix}0 & - {ω}_{e} {\tilde{M}}_{s} J \\ 0 & {ω}_{e} J\end{matrix} ] [ \begin{matrix}\hat{λ} \\ \hat{i}\end{matrix} ] + [ \begin{matrix}I \\ 0\end{matrix} ] u + G [ \begin{matrix}I \\ F\end{matrix} ] sign ( \hat{λ} - λ ) \qquad ( 33 )$$

where sign is a sign function, \hat{π}=[\hat{λ}_{α} \hat{λ}_{β}]^{T}; î=[î_{α} î_{β}]^{T}; G is a switching gain, which is equal to kI; F is a feedback gain matrix, which is equal to f₁I+f₂J; ~ is a parameter's nominal value when the parameter's error is considered; and ̂ is the state variables' estimated value. Thus the mismatch dynamics can be obtained as:

$$[ \begin{matrix}{λ}^{\dot{\_}} \\ {i}^{\dot{\_}}\end{matrix} ] = [ \begin{matrix}0 & - {ω}_{e} {M}_{s} J \\ 0 & {ω}_{e} J\end{matrix} ] [ \begin{matrix}\overline{λ} \\ \overline{i}\end{matrix} ] + G [ \begin{matrix}I \\ F\end{matrix} ] sign ( \hat{λ} - λ ) + [ \begin{matrix}Δ {M}_{s} \hat{i} \\ 0\end{matrix} ] \\ where [ \begin{matrix}\overline{λ} \\ \overline{i}\end{matrix} ] = [ \begin{matrix}\hat{λ} \\ \hat{i}\end{matrix} ] - [ \begin{matrix}λ \\ i\end{matrix} ] \qquad ( 34 )$$

are observer errors.

For bounded initial conditions, the switching gain G can be chosen as a negative number large enough that sliding mode can be enforced to confine the flux estimation error into the origin of the state plane. However, since the magnitude of chattering is proportional to the absolute value of gain G, it should be selected as small as possible while maintaining sliding mode.

The sliding mode occurs based on the condition:

λ̅^{T}· \overline{\dot{λ}}<0 (35)

Substituting the first row of mismatch dynamics equation, one can obtain:

λ̅_{α}[ωₑMₛī_{β}+G sgn(\hat{λ}−λ)+ΔMî_{α}]+ λ̅_{β}[−ωₑMₛī_{α}+G sgn(\hat{λ}−λ)+ΔMî_{β}]<0 (36)

Therefore, to make sure this inequality is satisfied, the gain can be selected to satisfy:

|G|>max{|ωₑMₛī_{β}+ΔMî_{α}|,|−ωₑMₛī_{α}+ΔMî_{β}|} (37)

Since electrical angular speed and α β axis current are not constant value, and the mutual inductance deviation:

ΔMₛ □ \tilde{M}ₛ≈Mₛ (38)

the gain can be simply selected as:

|G|=k|ωₑ_{_{—}}ₘₐₓ\tilde{M}ₛīₘₐₓ| (39)

where i_{—max} is the rated current, ωₑ_{_{—}}ₘₐₓ is the rated electrical angular speed, k is the salty factor, which can be selected as 1.5 or 2 to make sure the sliding mode occurs.

After the flux estimation error converges to zero, one has:

\overline{\dot{λ}}= λ̅=0 (40)

Substituting this equation into the mismatch equation (34), one can get the switching signal as:

G sgn(\hat{λ}−λ)=ωₑMₛJī=ΔMₛî (41)

Substituting this equation into the second row of mismatch dynamics equation, the current error can be derived as:

\overline{\dot{i}}=(ωₑJ+FωₑMₛJ)ī−FΔMₛî=[(ωₑ+f₁ωₑMₛ)J−f₂ωₑMₛI]ī−FΔMₛî (42)

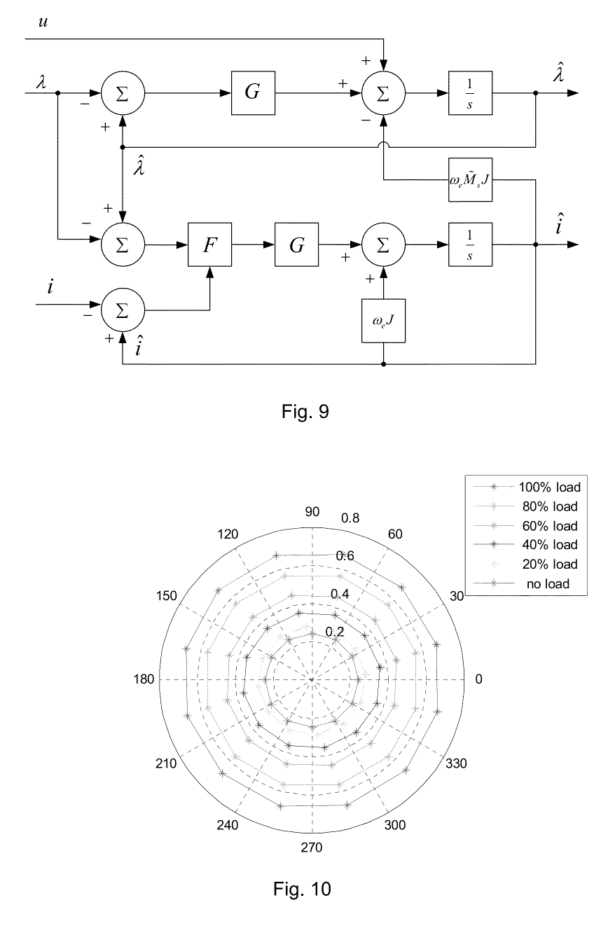

Therefore with proper selection of feedback gains f₁ and f₂, two poles of the proposed observer sensor can be placed to the left-half of the complex plane. Thus, estimated α and β axis current are able to tend to their actual value asymptotically. The overall system configuration is presented in FIG. 9.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

A search coil mounted PMSM for determining different fault conditions was simulated using FEA software package MAGNET® by Infolytica. The simulated PMSM included twelve search coils, each wound around a stator tooth. The search coil voltages are recorded, and the amplitude and phase of their first harmonic are taken for further analysis. Table I provides properties of the simulated PMSM. Table II summarizes the number of required search coils for different fault cases. Twelve search coils were chosen to analyze all the listed fault cases.

TABLE I
SPECIFICATIONS OF THE SIMULATED PMSM

| Number of poles pairs | 4 | |
|---|---|---|
| Phases | 3 | |
| Number of stator slots | 12 | |
| Rated power | 675 | W |
| Rated current | 15 | A |
| Rated speed | 2800 | rpm |
| Rated torque | 2.3 | Nm |
| Rated frequency | 60 | Hz |

TABLE II
NUMBER OF REQUIRED SEARCH COILS FOR FAULTS

| Fault case | Number of search coils required |
|---|---|
| Eccentricity | 3 |
| Demagnetization | Number of poles |
| Phase failure | Number of phases |
| Inter-turn fault | Number of solenoids |

FIG. 10 illustrates the voltage measured across each of the twelve search coils for different load conditions. In each condition, every star represents a search coil. In this polar figure, the amplitude of coil measured voltage is represented by the distance between the star and the figure center, in volts. It should be noted that the phase of the coil measured in volts is four times the phase of the corresponding star. This is because the phase difference between neighboring stars in this polar figure is 30 degree, whereas the phase difference between neighboring search coils is 120 degree.

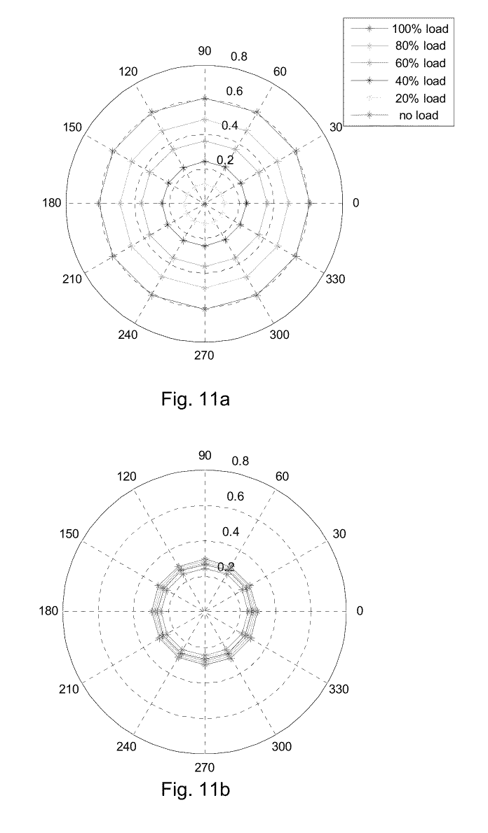

After decoupling is applied as discussed above, FIG. 10 can be transformed to FIG. 11, which is composed of (a) the armature reaction voltage, and (b) the field induced voltage. It should be noted that their phases are all zero due to decoupling. FIG. 11 demonstrates that under different load conditions, the armature MMF is proportional to the load, while the field MMF remains the same except some disturbance by d axis armature-induced MMF.

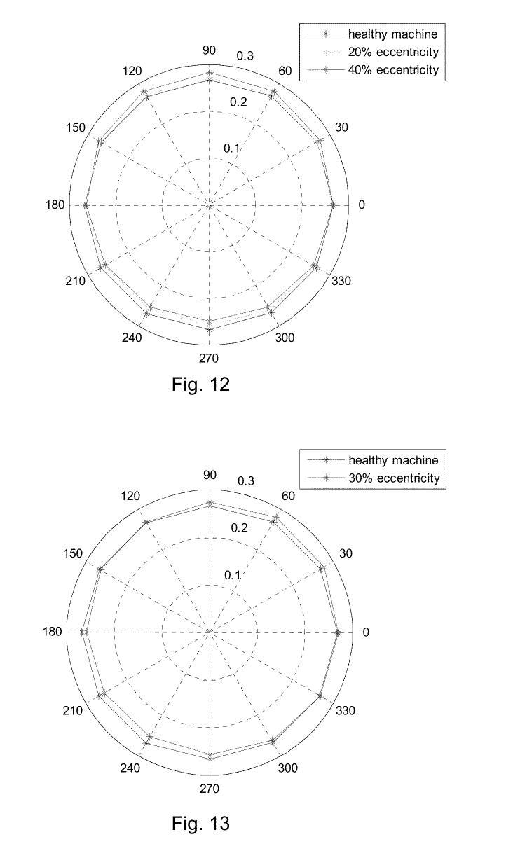

FIG. 12 shows the field component of measured voltage of the machine with 0.005 (20%) inch and 0.01 (40%) inch static eccentricity, compared with a healthy one. The eccentricity is in the upward direction, which corresponds to 90 degrees in these phasor diagrams. This slight shift to a 90 degree position in FIG. 12 can be easily observed.

FIG. 13 illustrates the case with a 30% dynamic eccentricity. FIG. 13 shows that there is a shift to a 45 degree position, which is the direction the rotor shifts when the data is collected. In the case of dynamic eccentricity, the shift direction rotates at the synchronous speed. FIG. 13 shows the curve at an arbitrary instant of time.

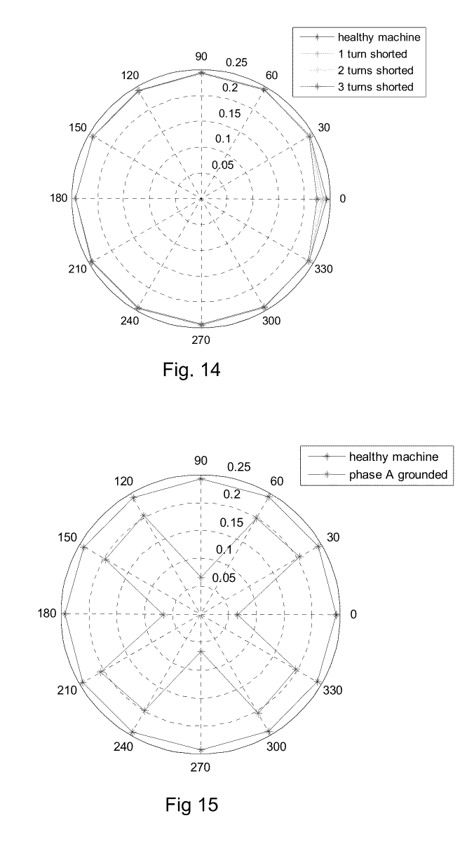

FIG. 14 shows three cases with one, two, and three turns of the armature coils around a tooth, which is at the 0 degree position, are inter-turn shorted. A change of Ampere-Turns at that position causes a distortion of armature MMF. It can be seen that the difference of various number of shorted turns can be distinguished, even with only one out of thirty turns is shorted.

FIG. 15 shows a case where one of the three phases is grounded. 1/3 of the magnitude of the flux linkage is remaining at the teeth of phase A, at the position 0, 90, 180 and 270 degree, produced by the neighboring phases, whereas 5/6 of the flux linkage is remaining at the teeth of phase B and phase C.

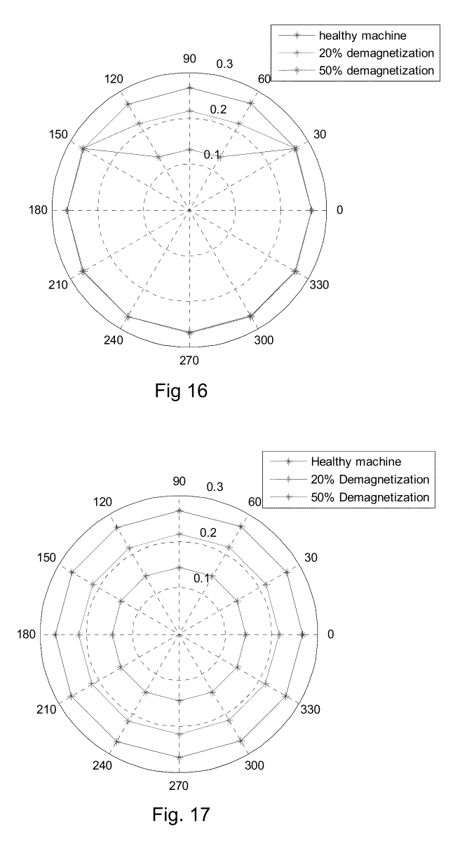

FIG. 16 presents the field component of the measured voltages in a partial demagnetized machine, in which one out of the four pole pairs is 20% and 50% demagnetized, respectively. As the rotor is revolving at the synchronous speed, the curves in this figure are time variant, revolving at the synchronous speed while retaining its shape. FIG. 16 shows the curve at an arbitrary time instant.

FIG. 17 presents the field component of measured voltages in a uniformly demagnetized machine, in which all the poles are 20% and 50% demagnetized, respectively. As the poles are in uniform demagnetization, even though the red curve in this figure revolves at the synchronous speed, it exhibits the same shape. Therefore, deterioration in magnetic performance of the permanent magnets can be detected from the field component of coils measured voltage.

The two-dimensional time transient FEA simulations verify the use of the search coils and decoupled armature flux and field flux in determining the condition of the electric machine, and types of fault due to position and magnitude of flux changes during machine operation. The simulation results demonstrate that the signatures of different faults are identifiable, so no time-consuming pattern recognition algorithm is required. Furthermore, the direction of eccentricity and the location of winding shorted turns can be found. In addition, this method is also capable of evaluating the severity of each fault, which is of significant importance in mission critical applications such as automotive, aerospace and military applications.

A further simulation was conducted to demonstrate the use of the search coils as a “universal” sensor, such as for detecting conditions such as current and/or rotor position. A test machine and a corresponding FEA model were prepared. The three phase Y-connected machine had a concentrated armature winding and a sinusoidal back EMF. Details of its specifications of the PMSM are summarized in Table III. A search coil was wound, with four turns each, around each of the 12 stator teeth. Among the twelve search coils, any three of them on a three phase “tooth” can be used as the sensor. The sensor voltages were recorded by the monitoring device data acquisition system for further analysis.

TABLE III
SPECIFICATIONS OF THE PRESENTED PMSM

| Number of poles pairs | 4 | |
|---|---|---|
| Phases | 3 | |
| Number of stator slots | 12 | |
| Rated power | 675 | W |
| Rated current | 15 | A |
| Rated speed | 2800 | rpm |
| Rated torque | 2.3 | Nm |
| Rated frequency | 60 | Hz |

| | |
|---|---|
| Back EMF constant | 18.5 V(peak, line-line)/krpm |

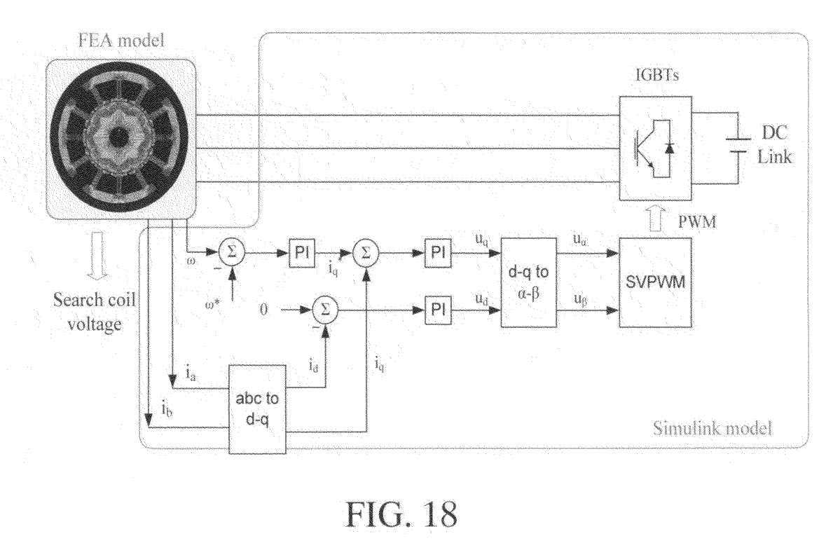

In FEA simulation, the dynamics due to transistor switching cannot be simulated, therefore co-simulation of MagNet° and Simulink® was performed. In the co-simulation, the machine was electromagnetically and mechanically modeled and simulated by FEA, while the control circuit and switching devices are modeled and simulated by Simulink®. Therefore the effect on the search coils due to switching dynamics is taken into account. FIG. 18 illustrates the vector control topology for co-simulation, which was conducted in this example.

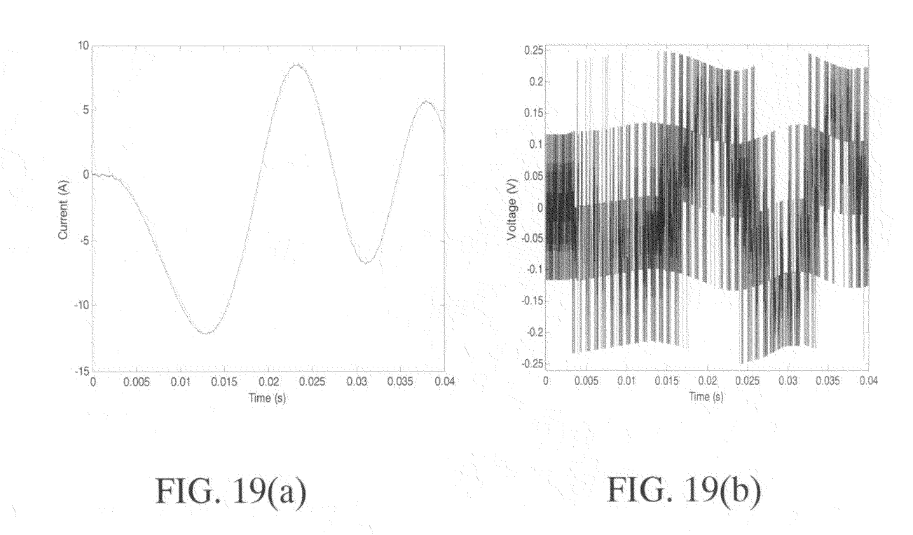

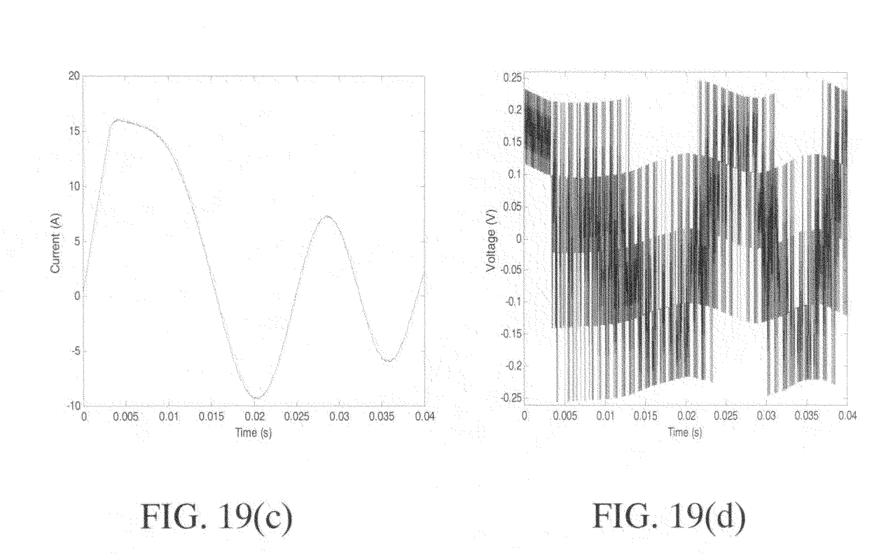

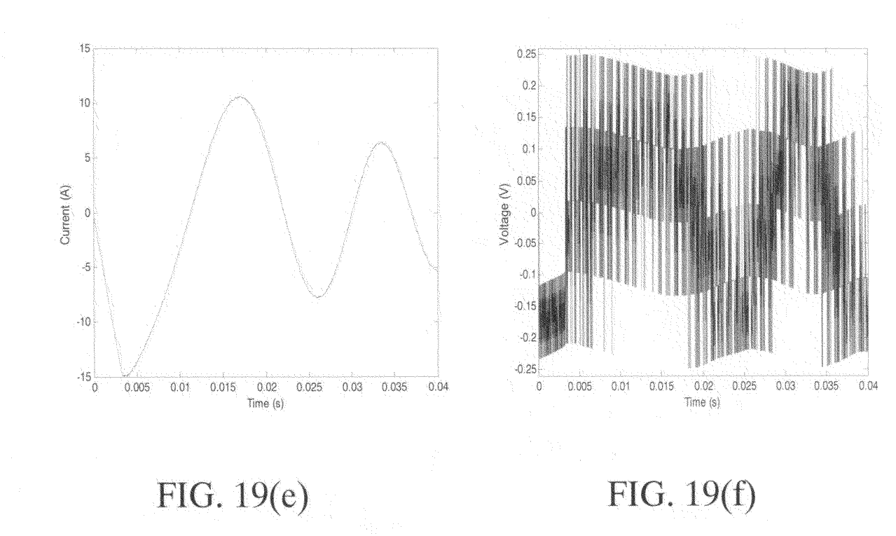

The position estimator is typically less, or not suitable for zero or low speed operation, and thus the performance at starting state was examined. The machine was vector controlled with 10 kHz switching frequency. Loaded torque was 0.4 Nm, and it had a high starting current that then decayed. Three phase current and corresponding search coil voltage at the starting condition are presented in FIG. 19.

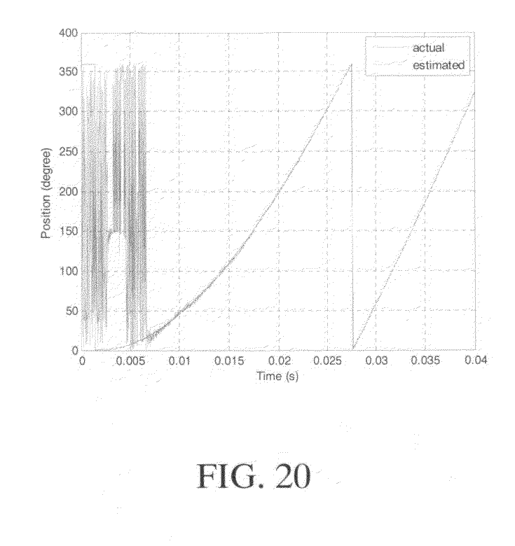

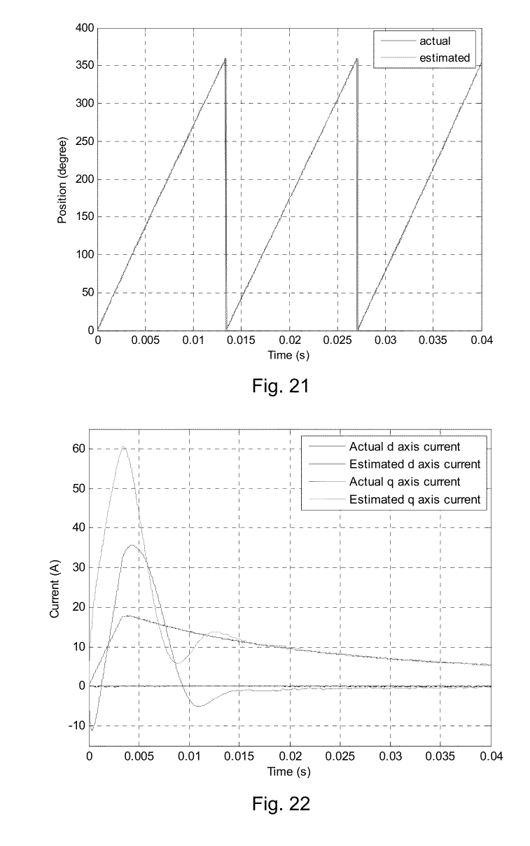

Projecting the three phase current and search coil voltage into a rotating d-q reference frame with an estimated rotor angle in a previous state, and implementing equation (23) to the loop, the estimated rotor position was obtained as shown in FIG. 20. It was seen that the estimation error converges to zero after 0.007 s, which corresponded to a speed of 31 rads (74 rpm for the test machine). The case of steady state was also examined. The result is presented in FIG. 21. The zoomed result showed the electrical angular error is less than 2°, which is a very good estimation.

Performance of the current observer was verified under the same machine operation condition. The machine was vector controlled with applied torque of 0.4 Nm. FIG. 22 shows the estimated current base on the three phase search coils voltage provided in FIG. 19 and known rotor position provided in FIG. 20. It was seen that estimated current converges to actual ones faster than the phase current dynamics in vector control.

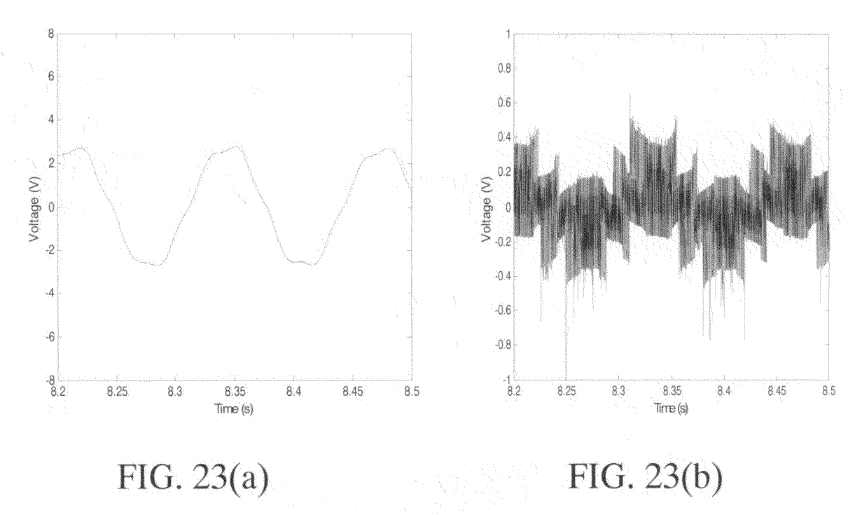

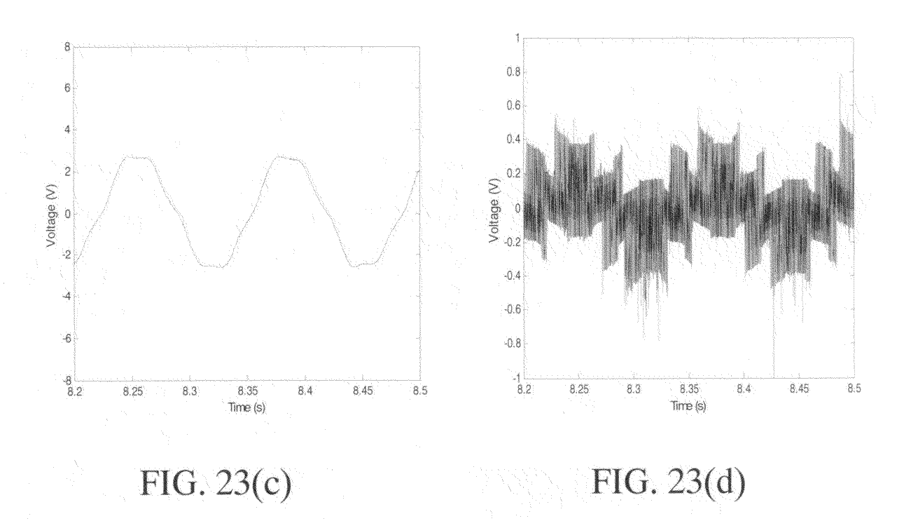

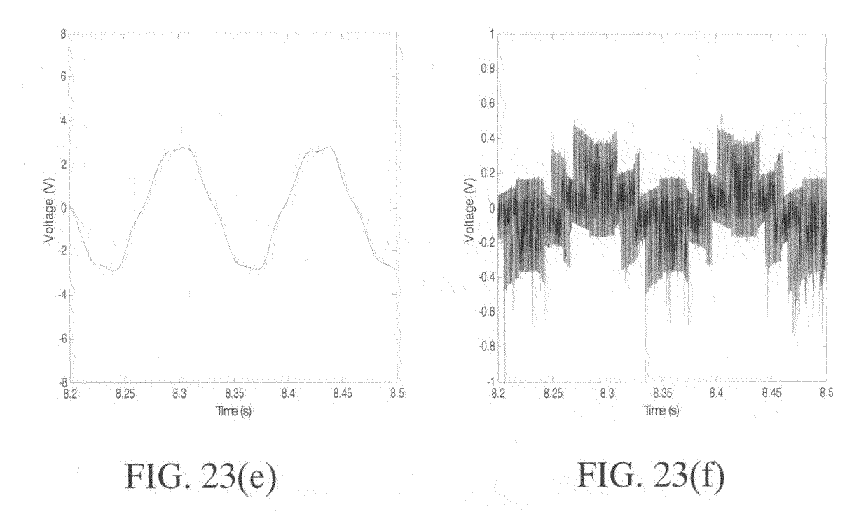

An experiment implementation was also conducted for verification of the simulation. The test machine was the one which has been introduced above. A TI DSP TMS320C2812 performed all necessary signal processing tasks for vector control, with a PWM frequency of 8 kHz. Current was detected by LEM's current transducer LTS 25-NP for each phase of the machine. A gate driver PCB and sensor PCB were self-designed and self-made in the lab. A 1000 line incremental raster encoder was equipped as a position sensor for the machine. Voltages of the three search coils were monitored by a 16-bit data monitoring device acquisition system with a sampling frequency of 30 kHz. Vector control was implemented to control the test machine, with a load of approximate 0.4 Nm at steady state. Similar to the co-simulation, three phase current and corresponding search coil voltage condition are shown in FIG. 23. To make the figure clear and avoid repetition, only a time slot of 0.3 second is presented in these figures. During that time, the machine is running at steady state.

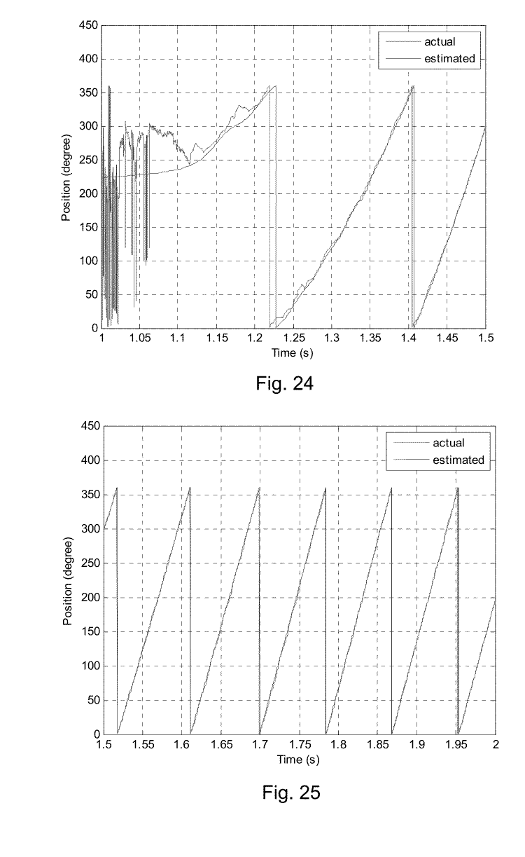

FIGS. 24 and 25 show performance of the position estimator in the case of starting and steady state respectively. The result is presented in FIG. 20. From FIG. 24, it was seen that the estimation error converged to zero after 1.3 s, which corresponded to a speed of 64 rpm for this 8 pole test machine. In the case of steady state, the zoomed result showed the maximum angular error was 8°, which was corresponding to 2 mechanical degrees.

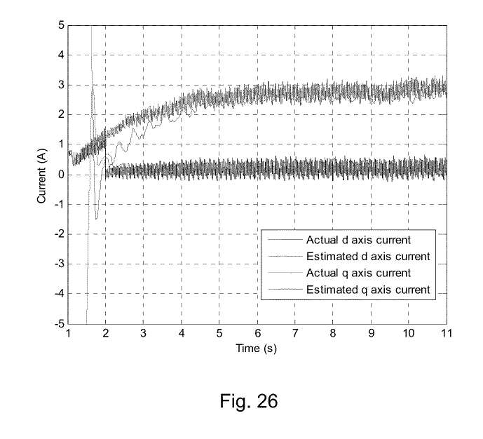

Performance of the current observer was also experimentally verified under the same machine operation condition. FIG. 26 shows the estimated current base on the three phase search coils voltage provided in FIG. 19 and known rotor position provided in FIG. 20. It was seen that estimated current converges to actual ones asymptotically, with it being a bit slow at starting.

The simulation and experimental verification demonstrate the use of the search coils as a sensor, such as for providing redundancy for the machine's current and/or position sensor.

Thus, the invention provides a device and method for use in determining conditions of an electric machine. The structure provides for monitoring and determining machine conditions such as eccentricity, armature winding short-turn, demagnetization faults and also current and rotor position. The search coils of this invention can easily be implemented during manufacturing to provide the robust monitoring features.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method for determining a condition of an electric machine including a rotor and a stator, the method comprising:
measuring a magnetic machine flux of the electric machine;
measuring a field flux of the rotor; and
determining with a data processor in combination with the electric machine an armature flux of the stator as a function of the measured field flux and the measured magnetic machine flux.

2. The method of claim 1, further comprising measuring at least one of the magnetic machine flux or the field flux using a search coil in combination with the stator and the data processor.

3. The method of claim 2, wherein the search coil comprises a winding around a tooth of the stator.

4. The method of claim 2, further comprising a plurality of search coils in combination with the data processor, each of the search coils wound around a tooth of the stator, and determining an armature flux at each of the search coils.

5. The method of claim 1, further comprising operating the electric machine without an introduced power current to measure the field flux of the rotor.

6. The method of claim 1, further comprising operating the electric machine with an introduced power current to measure the magnetic machine flux.

7. The method of claim 1, wherein determining the armature flux comprises the data processor decoupling the field flux from the magnetic machine flux using rotor position and three phase currents in a vector calculation.

8. The method of claim 1, further comprising determining a fault during operation of the electric machine by determining an initial machine field flux and an initial machine armature flux and monitoring an operating field flux and an operating armature flux during operation of the electric machine.

9. The method of claim 1, further comprising monitoring a voltage of search coils in combination with the stator and estimating at least one of rotor position or machine current as a function of the voltage.

10. A method for determining a condition of an electric machine including a rotor and a stator, the method comprising:
providing a first electric machine property selected from at least one of a first field flux of the rotor or a first armature flux of the stator;
determining with at least one of a sensor or a data processor in combination with the sensor during operation of the electric machine a second electric machine property selected from at least one of a second field flux of the rotor or a second armature flux of the stator;
the data processor comparing the second electric machine property with the first electric machine property; and
the data processor determining a potential or actual machine fault during operation of the electric machine upon the second electric machine property differing from the first electric machine property by a predetermined amount.

11. The method of claim 10, wherein the sensor comprises a search coil wound around a tooth of the stator and in combination with the data processor.

12. The method of claim 10, wherein the first electric machine property is predetermined prior to use of the electric machine.

13. The method of claim 10, wherein the first electric machine property is determined by operating the electric machine using an external machine and without powering the electric machine.

14. The method of claim 10, further comprising determining an eccentricity fault by monitoring for a displacement within the electric machine between the second electric machine property and the first machine property.

15. The method of claim 10, further comprising determining a stator short circuit fault by monitoring for a difference between the second armature flux and the first armature flux.

16. The method of claim 10, further comprising determining a rotor demagnetization fault by monitoring for a difference between the second field flux and the first field flux.

17. The method of claim 10, further comprising monitoring a voltage of search coils in combination with the stator and estimating at least one of rotor position or machine current as a function of the voltage.

18. A method for determining a condition of an electric machine including a rotor and a stator, the method comprising:
measuring with a data processor an induced voltage formed on a search coil wound around a stator of the electric machine;
detecting one of stator current or rotor position with a sensor and the data processor;
determining with the data processor an other of the stator current or rotor position as a function of the induced voltage.

19. An electric machine, comprising:
a rotor including a permanent magnet;
a stator including a plurality of stator teeth, each of the stator teeth including an armature winding;
a plurality of search coils, each of the search coils wound around a different one of the stator teeth; and
a monitoring device in communicating combination with each of the search coils, the monitoring device receiving induction voltage from the search coils and including a data processor determining an armature flux from the induction voltage or determining rotor flux from measured armature current and collective magnetic flux.
